(19) United States
(12) Patent Application Publication
(10) Pub. No.: US 2026/0074730 A1
(43) Pub. Date: Mar. 12, 2026

(54) BIOLOGICAL TISSUE DETECTION USING DIFFERENTIAL BEAMFORMING IN MOBILE COMMUNICATION SYSTEMS

(71) Applicant: Google LLC, Mountain View, CA (US)

(72) Inventors: Mohammad Reza Ghajar, Redwood City, CA (US); Erik Stauffer, Sunnyvale, CA (US); Jibing Wang, San Jose, CA (US)

(21) Appl. No.: 19/107,486

(22) PCT Filed: Oct. 21, 2022
(86) PCT No.: PCT/US2022/078535

§ 371 Date: Feb. 27, 2025

(51) Int. Cl. H04B 1/3827; G01S 7/41; G01S 13/04; H01Q 1/24; H01Q 21/24; H04W 52/18

(52) U.S. Cl. CPC H04B 1/3838; G01S 7/411; G01S 13/04; H01Q 1/243; H01Q 21/24; H04W 52/18

(57) ABSTRACT

A method comprising transmitting, via a first antenna array of a mobile communication device, a plurality of transmit beams, and receiving, via a second antenna array of the mobile communication device, a plurality of receive beams. Each beam pair of a plurality of beam pairs includes a respective transmit beam of the plurality of transmit beams and a respective receive beam of the plurality of receive beams. Then determining, based on a comparison between beam pairs of the plurality of beam pairs, whether an object is proximate to the mobile communication device. Then responsive to determining that the object is proximate to the mobile communication device, determining one or more transmission parameters. Then transmitting, with the one or more transmission parameters, a signal.

### BACKGROUND

Wireless communication systems may use radio frequency (RF) signals to transfer data from a transmitter to a receiver. For instance, a transmitter may include an antenna system that outputs RF signals, which propagate into the surrounding space, and are received by a receiver having an antenna system tuned to receive the RF signals. As RF signals propagate from the transmitter to the receiver, the RF signals may interact with surrounding objects. Objects in close proximity to the antenna system are impacted by RF signals differently, and objects negatively affect RF signal transmissions far more than air, and as a result of which objects may negatively impact device efficiency. In particular circumstances, objects in close proximity to the antenna system may cause a reduction in received signal strength from the absorption of electromagnetic energy.

### SUMMARY

In general, this disclosure is directed to devices and techniques for determining whether biological tissue is close proximity to an antenna system of a wireless device. Wireless communications systems may use an RF transmitter electromagnetically coupled to a transmit antenna system. The RF transmitter and transmit antenna system may be configured to transmit electromagnetic energy to a receive antenna system, electromagnetically coupled to a RF receiver. The receive antenna system may benefit by increasing the amount of energy transmitted from the transmit antenna, as the physical distance between the transmit antenna and receive antenna increases. Increasing the amount of energy transmitted, may increase the intensity of the electromagnetic fields near the transmit antenna. Increasing the amount of energy transmitted may hasten the energy depletion rate of a battery used by the mobile communication device. Being able to determine whether biological tissue is proximate to a transmit antenna, allows the antenna system to respond by selecting antennas associated with a more efficient transmission path thereby requiring less transmission energy preserving the energy of the battery.

In accordance with one or more aspects of this disclosure, a device may determine whether biological tissue is present near an antenna system of the device. For example, transmitting and receiving electromagnetic energy simultaneously with differential beamforming arrays, allows one to ascertain whether biological tissue is near a transmit antenna system. Some examples of this disclosure are directed to a method for detecting such tissue near a mobile communication device, configured to use differential beamforming techniques, implemented with antenna arrays.

The mobile communication device may transmit a group of transmit beams from a transmit antenna array. The mobile communication device may also receive with a group of receive beams received by a receive antenna array. Each transmit receive beam pair may include a transmit beam and a receive beam. Using the transmit receive beam pairs, the mobile communication device may transmit electromagnetic energy with a variety of transmit beams. The electromagnetic energy may reflect off various objects, thereby causing the electromagnetic energy to propagate back toward the antenna array. Using the transmit and receive beam pairs, the mobile communication device may receive the reflected electromagnetic energy with a variety of receive beams. Upon determining that an object, having electromagnetic properties of biological tissue, is close to the transmit antenna array, the mobile communication device may adjust transmission parameters for subsequent transmissions.

By adjusting transmission parameters, the wireless communication system may effectively lower the intensity of electromagnetic energy in a selective manner to comply with Specific Absorption Rate (SAR) requirements, improve channel quality between a transmitter and receiver, and preserve the electrical energy stored in the battery. In some examples, transmission parameters may include parameters that adjust the transmitted power or antenna gain patterns.

As one example, a method includes transmitting, via a first antenna array of a mobile communication device, a variety of transmit beams and receiving, via a second antenna array of the mobile communication device, a variety of receive beams, a variety of beam pairs each including a respective transmit beam of the variety of transmit beams and a respective receive beam of the variety of receive beams. The method further includes determining whether a biological tissue is proximate to the mobile communication device based on a comparison between beam pairs of the variety of beam pairs, and, responsive to determining that the biological tissue is proximate to the mobile communication device, determining one or more transmission parameters. The method further includes transmitting a signal with the one or more transmission parameters.

As another example, a mobile communication device including a first antenna array configured to transmit a variety of transmit beams. The mobile communication device also including a second antenna array configured to receive a variety of receive beams. A variety of beam pairs each including a respective transmit beam from a variety of transmit beams and a respective receive beam from a variety of receive beams. The mobile communication device also includes one or more processors configured to determine whether an object is proximate to the mobile communication device based on a comparison between beam pairs in the variety of beam pairs. The mobile communication device also includes a radio configured to determine one or more transmission parameters and transmit a signal upon determining that an object is proximate to the mobile communication device, using the one or more transmission parameters.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example of a wireless communication device that is configured to detect biological tissue proximate to an antenna array of the wireless communication device, in accordance with one or more techniques of the disclosure.

FIG. 2 is a conceptual block diagram illustrating an example of a millimeter wave module generating transmit and receive beams, in accordance with one or more techniques of the disclosure.

FIG. 3A through 3C are conceptual illustrations of examples of antenna arrays used in a mobile communication device, in accordance with one or more techniques of this disclosure.

FIG. 4 is a conceptual block diagram illustrating an example of a dual polarized receiver used to process the signals received by a variety of receive beams, in accordance with one or more techniques of the disclosure.

FIG. 5 is a conceptual graph illustrates an example of a difference power matrix plotted against a plurality of transmit beam identifiers in a variety of environments, in accordance with one or more techniques of the disclosure.

FIG. 6 is a conceptual flow chart illustrating an example of a method for detecting biological tissue proximate to an antenna array of a mobile communication device, in accordance with one or more techniques of the disclosure.

### DETAILED DESCRIPTION

A mobile communication device or wireless communication device may be a digital device that transmits and receives data via a radio frequency (RF) link. The term mobile communication device and wireless communication device may be used interchangeable and mean the same thing. A wireless communication system may refer to a second mobile communication device or it may refer to a more complex communication system such as a wireless base station, wireless router, or wireless relay. The mobile communication device may be attempting to communicate with a wireless communication system. In some examples, the wireless communication system may be another mobile communication device, a base station, a wireless router, a wireless relay, or other wireless system which can transmit and receive data via an RF link.

Some examples of a mobile communication devices include a mobile telephone, a wireless watch, wireless glasses, wireless pedometer, wireless headphones, and wireless health sensors. Mobile communication devices may output RF energy when transmitting data via a RF link to another wireless communication system. When a mobile communication device is outputting RF energy, it may be configured to use an RF transmitter. Wireless communication devices may receive RF energy when receiving data via a RF link, from another wireless communication system. When a wireless communication device is receiving RF energy it may be configured to use an RF receiver. In some examples, the wireless communication device may be configured to output RF energy, or receive RF energy, even when it is not actively transmitting or receiving data. For instance, as discussed in further detail below, transmitting and receiving RF energy may be useful in detecting the proximity of a user to the mobile communication device.

In some wireless devices, a portion of a user's body may be located in close proximity to a mobile communication device. External output peripherals may be integrated into the wireless device, in order to interact with the sensory perception of the user. Some examples of external output peripherals include a display, motor, light emitting diode (LED), speaker, or other output peripheral. The output peripherals may use the sensory perception (e.g., sight, smell, taste, touch, or hearing) of the user to communicate information. Because the wireless device may use the sensory perception of the user to communicate information, the user may be in close proximity to the wireless communication device. In some examples, the user may be holding the wireless communication device against the biological tissue (e.g., the skin, the hair, the organ, or the muscle) of the wearer. Because the wireless communication device may communicate wireless data to another wireless communication system, the wireless communication device may transmit RF energy when the wireless communication device is close in proximity to biological tissue. In some examples, the user may be holding the wireless communication device next to the skin of the user when the mobile communication device transmits wireless data to another wireless communication system.

In some examples the mobile communication device may transmit wireless data to a wireless communication system that is physically far away. In some examples, the physical distance between the mobile communication device and the wireless communication system may not be shortened. As the distance between a wireless transmitting device and a wireless receiving device increases, the power density received by the wireless communication system diminishes. If the power density is too low for the receiving wireless communication system, the wireless communication device may not be able to receive the data. In order to increase the power density at the wireless communication system, the transmitter on the mobile communication device may increase an electromagnetic energy intensity of the electromagnetic energy transmitted from its antenna.

In some examples, a cellular telephone may be a mobile communication device, and a base station may be a wireless communication system. The cellular telephone may transmit data to a wireless base station located one to two miles away. In some examples, a cell phone may transmit high intensity electromagnetic energy so that a signal with enough power density is received by a receiver on the base station. In some examples the tissue of a user may be close proximity to the wireless communication device when transmitting with high intensity electromagnetic energy. In accordance with one or more techniques of this disclosure, the cell phone may be held in the hand of the user when communicating with a base station far away from the cell phone, requiring the cell phone to output high intensity electromagnetic energy. Outputting high intensity electromagnetic energy may demise the charge of a battery more quickly than average or low intensity electromagnetic energy.

In some examples, the close proximity of biological tissue to an antenna system may result in the antenna system increasing the intensity of the electromagnetic energy transmitted from it. Increasing the intensity of the electromagnetic energy transmitted from the mobile communication device will increase the energy draw from the battery and lower the operating time between battery charges. In order to transmit a signal to a receiver with a higher energy density without increasing the energy intensity of the transmit signal, the antenna gain may be manipulated. Using a phased array, the antenna gain pattern of an antenna array may be changed. In some examples, changing the antenna gain pattern by increasing the antenna gain in the direction of the receiver and lowering the antenna gain in the direction of the human tissue may prevent the mobile communication device from increasing the intensity of the signal while maintaining or increasing channel quality. By preventing the mobile communication device from increasing the intensity of the signal, the operation time of a signal battery charge is increased or the communication path improved.

In accordance with one or more techniques of this disclosure, a device may determine whether biological tissue is present near a transmit antenna system of the device. For example, transmitting and receiving electromagnetic energy, simultaneously, with differential beamforming arrays, may allow one to determine whether a biological tissue is near the antenna system. Some examples of this disclosure are directed to a method for determining whether such tissue is near a wireless communication device using differential beamforming implemented with antenna arrays.

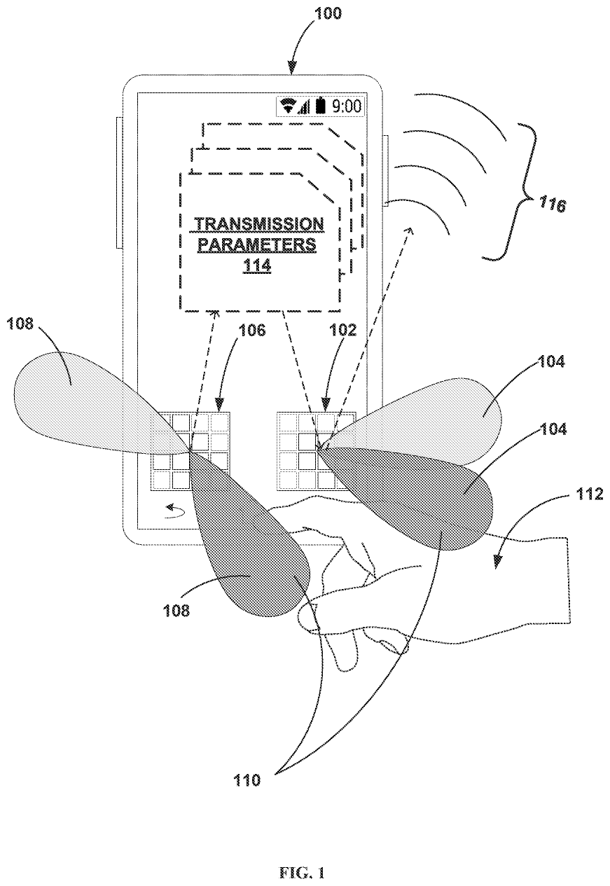

FIG. 1 is a conceptual diagram illustrating an example of a wireless communication device 100 that is configured to detect biological tissue 112 proximate to an antenna array 106 or 102 of the wireless communication device, in accordance with one or more techniques of the disclosure. Some examples of wireless communication device 100 include a mobile phone that may transmit data to, and receive data from, a second wireless communication device. In some examples the second wireless communication device may be a base station. In some examples the base station may be distant from the wireless communication device (e.g., up to about 3, 4, 5, or 6 miles away).

In some examples of FIG. 1, the wireless communication device 100 may utilize a method to detect whether biological tissue 112 (e.g., human hand, human head, human body, or material with properties of human tissue) is in close proximity to the mobile communication device 100. Using the transmit array, the mobile communication device may transmit energy from a plurality of transmit beams. The energy in the transmission may reflect off objects in close proximity, such as biological tissue. Once reflected off an object, the electromagnetic energy may propagate back to the mobile communication device. The receive antenna array, used by the mobile communication device, may receive the energy using a plurality of receive beams. In some examples, each transmission from a transmit beam may be received by a selected receive beam. The receive beam may be selected by the wireless communication device, to receive the reflected energy. In some examples, a beam pair may comprise a transmit beam generating the transmission, and the receive beam receiving the transmission. Each beam pair of a plurality of beam pairs includes a respective transmit beam, of the plurality of transmit beams, and a respective receive beam of the plurality of receive beams.

In some examples of FIG. 1, the wireless communication device may make a comparison of the energy transmitted and received, between the beam pairs of the plurality of beam pairs. Based on the comparison, the wireless communication device may determine whether biological tissue is proximate to the mobile communication device. In some examples, the comparison includes comparing the received power from the reflected energy to a threshold value. The threshold value may be a value determined from testing and/or calibration. In some examples, received power below the threshold value indicates that human tissue is not present, or is far enough away from the transmit beam so as not to significantly impact the signal power density at the receiver. A receive power level above the threshold value may indicate that biological tissue is present or is in close proximity to the transmit beam. If the biological tissue is present or in close proximity to the transmit beam, electromagnetic energy density received by the receiver may be too low for detection without increasing the transmit power. A receive power level above the threshold value may indicate that the electromagnetic energy is not being efficiently transmitted to the receiver. In particular, the electromagnetic power intensity may be reduced by reconfiguring the transmit beams, away from the tissue, to improve the signal quality (for example as measure by Received Signal Strength Indicator (RSSI)) for communications with a remote device, without increasing transmission power thereby preserving the battery charge.

In some examples of FIG. 1, upon determining biological tissue is proximate to the mobile communication device, the mobile communication device may respond by determining one or more transmission parameters and transmitting a signal based on the one or more transmission parameters. In some examples, the transmission of the signal may be with the one or more transmission parameters.

In some examples of FIG. 1, wireless communication device 100 may be a smart phone, a tablet, a laptop, wireless reader, wireless headphones, smart watch, or other body worn wireless communication device. Other body worn wireless communication devices, may include any device in close proximity to the body, (e.g., less than a few feet) that transmits, RF, millimeter wave, or micrometer wave electromagnetic signals, through the use of a regularly charged battery. Mobile communication devices may use a variety of wireless communication techniques. Some examples of mobile communication device 100 may utilize a wireless communication protocol such as mobile communication techniques. Some mobile communication techniques include 3G, 4G, 5G, and or 6G communication technology. These include Global System for Mobile Communications (GSM), Frequency Division Multiplexing (FDM), Time Division Multiple Access (TDMA), Orthogonal Frequency Division Multiplexing (OFDM), Multiple Input Multiple Output (MIMO).

In some examples of FIG. 1, the mobile communication device 100 may comprise a transmitter with a transmit antenna array 102 and a receiver with a receive array 106. In some examples, the transmit array 106 may be configured to transmit a plurality of transmit beams. In some examples, the receive array 106 may be configured to receive with a plurality of receive beams. If the transmit array and receive array are separate arrays, a first array may be designated as a transmit array and a second array may be designated as a receive array. A transmit array, may be an array of antenna elements collocated on an exclusive transmit antenna array printed circuit board (PCB). A receive array, may be an array of antenna elements collocated on an exclusive receive antenna array printed circuit board (PCB). In some examples, a first array may be an array of antenna elements collocated on a phased array beamforming integrated chip (IC). A second array may be an array of antenna elements collocated on a phased array beamforming integrated chip (IC).

In some examples of FIG. 1, the transmit array 106 and the receive array 102 may be part of a millimeter wave module. A millimeter wave module may be used to configure a transmit array to transmit a plurality of transmit beams. In some examples, a millimeter wave module may be used to configure a receive array to receive with a plurality of receive beams. The millimeter wave module may be controlled by a processor in the mobile communication device.

In some examples, transmit array 106 and receive array 102 may be configured to generate transmit beams 104 and receive beams 108. Transmit beams 104 and receive beams 108 may comprise multiple gain pattern antenna lobes. Some antenna lobes may be side lobes. In some examples, these antenna lobes may be generated by configuring an antenna array 102 or 106 to produce antenna nulls. An antenna null is an angular position in the antenna gain pattern where the antenna gain drops significantly below gain values at angular positions near the location of the null. Some nulls may separate an antenna beam into multiple beams. In some examples, nulls may be position in the center of a main beam, dividing the main beam into multiple beams. Some examples may include configuring the antenna array to transmit signals that destructively interfere, thereby creating a null along the portion of the propagation path where the destructive interference occurs.

In some examples of FIG. 1, the mobile communication device 100 may use transmission parameters 114 to transmit a signal. In some examples, transmission parameters may include parameters relevant to transmit power density of a transmission. Some examples of transmission parameters include, transmit beam selection, transmit power levels, modulation type, transmission duration, and transmitting radio selection. In some examples, transmission parameters may be used to monitor the presence of biological tissue. In some examples, transmission parameters 114 may be used to lower the electromagnetic power density of the transmission, thereby preserving the operational time of a single battery charge. In some examples, transmission parameters may be used to lower the self-jamming power received by the mobile communication device reflected off the biological tissue when the mobile communication device is simultaneously transmitting and receiving.

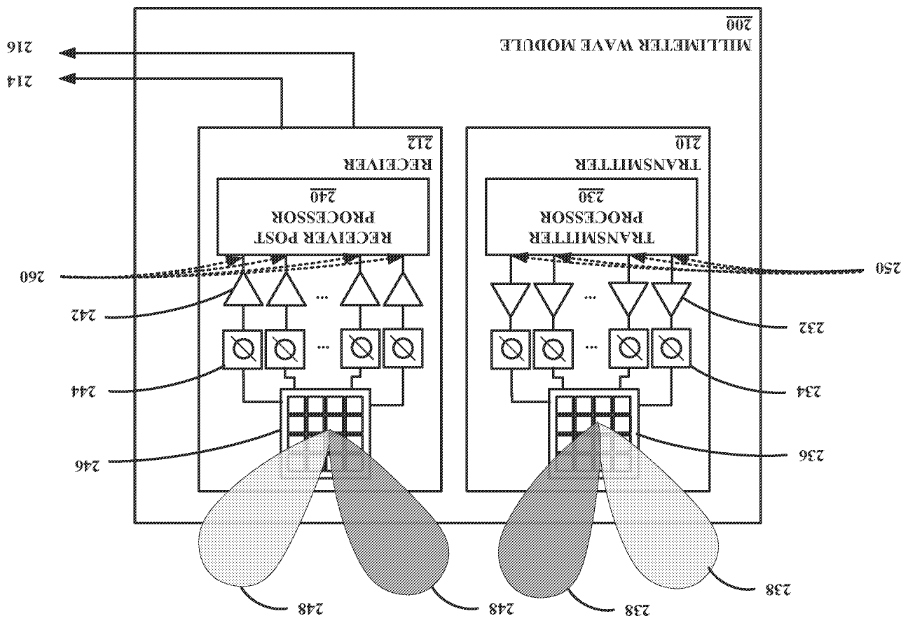

FIG. 2 is a conceptual block diagram illustrating an example of a millimeter wave module generating transmit and receive beams, in accordance with one or more techniques of the disclosure. In some examples, millimeter wave module 200 may comprise a transmitter 210 and receiver 212 to be used in a mobile communication device 100 in FIG. 2. The transmitter 210 may further comprise a transmitter processor 230. The transmitter processor 230) may be configured to generate a plurality of signals. Each signal is sent down a unique channel 250. Each channel is connected to separate amplifier 232 and later connected to a separate phase shifter 234 before terminating in a separate element of an antenna array 236. In some examples, a dual polarized antenna array may be used. If a dual polarized antenna is used, two channels may be directed to the same antenna element. If a nonpolarized antenna array is used, each channel may be electromagnetically coupled to an exclusive antenna element for each channel.

In some examples of FIG. 2, the receive beams 248 may be produced by antenna array 246. Each element in the antenna array 246 may receive a unique copy of the incoming signal. Each antenna element may transmit the copy of the signal down the channel path connected to the element. Wherein the channel path is one channel path in a plurality of channel paths 260. Each channel path may have a phase shifter 244 and an amplifier 242. All the channels may terminate in a receiver post processor 240. The receiver post processor may digitize and correlate the signals received on the plurality of receive channels 260. Using the result of the digitized and correlated data, the receive post processor my produce two output data streams 214 and 216. Data streams 214 and 216 may be further processed by one or more processor in the mobile communication device in accordance with one or more techniques of this disclosure.

In some examples, transmitter processor 230 may include one or more signal generators configured to send phase shifted copies of the same signal down various channels 250. Additionally, the transmitter processor may send phase aligned signals down the same path and use a variety of analog amplifiers 232 and analog phase shifters 234 to alter the signals in the respective channels 250. In some examples the transmitter processor may also alter the amplitude of the signals traveling down the plurality of channels 250. Additionally, in other examples amplitude modifications may be adjusted using analog amplifiers 232. Some examples of this disclosure include the use of Digital to Analog Converters (DACs) in the transmitter processor. DACs are configured to take as an input, digital data representing a digital signal, and output an analog signal. A DAC may not have enough voltage swing to produce a signal with enough gain. In some examples where the DAC is a low power DAC, the amplification and phase shifting may be done with external amplifiers 232 and phase shifters 234, respectively.

In some examples, amplifier 232 may include power amplifiers. In examples where external power amplifiers are used in place of digital amplifiers, the power amplifier may take a variety of forms. In some examples power amplifiers 232 may include distributed power amplifiers, comprising transmission lines and semiconductor switches. The power amplifiers may also be integrated onto Integrated Chips (ICs). Power amplifier further may be fully integrated into modules or packages that connect to the plurality of channels 250 via a Printed Circuit Board (PCB), wires, transmission line, wave guide, twisted pair, or other signal distribution method. Due to the variability in manufacturing and placement, power amplifiers of the same design, may have some variability in gain. Additionally power amplifiers gain may not be easily adjusted. As such, in some examples, the power amplifier may also incorporate a variety of adjustable gain attenuators.

In some examples, the adjustable gain attenuators (not illustrated in FIG. 1) may be incorporated within the amplifier. The adjustable attenuator may configuration of the amplifier with a wire range and accuracy of gains setting that may be achievable with exclusively a power amplifier. Additionally, adjustable gain attenuators may be incorporated into the transmitter processor 230 as adjustable gain attenuators or as Firmware (FW), used to control the amplitude of the signal produced by the integrated DACs. Adjustable gain attenuators and power amplifiers may also have some variability in phase delay. This variability in phase delay may be compensated for with transmit phase shifters 234.

In further examples, transmit phase shifters 234 may serve a variety of purposes. One purpose may be to calibrate out unwanted phase delays due to variability in transmit components. Some components, including power amplifiers 232, transmitter processor 230, and antenna elements (e.g., antenna elements of transmit array 236), may cause unwanted phase delay. Another purpose for phase shifters may be to manipulate the phase front produced by the transmit antenna array 236. The transmit antenna array 236 may produce a phase front by combining the contributions of electromagnetic signals from the plurality of antenna elements. Because the contributions happen simultaneously, the antenna array may produce a transmit beam with a main lobe pointed in a variety of directions based on the manipulation of phase shifters 234.

In FIG. 2, receive phase shifters 244 may serve a variety of purposes. One purpose may be to calibrate out unwanted phase delays due to variability in receive components. Some components, including low noise amplifiers 242, receive post processor 240, and antenna elements (e.g., antenna elements of receive array 246), may cause unwanted phase delay. Another purpose for phase shifters may be to manipulate the phase front of the receive antenna array 246. The receive antenna array 246 may produce a receive beam configured to receive electromagnetic signals with a particular phase front. The receive antenna array may receive electromagnetic waves from phase fronts arriving in a range of directions. The receive phase shifters may be used to delay particular copies of the electromagnetic wave received by particular receive antenna elements in receive array 246. The receiver post processor may then combine the phase shifted copies, reconfiguring the signal received by a particular receive beam. In some examples, the receive phase shifters may delay particular copies of the electromagnetic signal down particular channels in the plurality of channels 260 to compensate for later delays from receive components such as the amplifiers 242.

In some examples, amplifiers 242 may include low noise amplifiers (LNAs). In examples where LNAs are used in place of digital amplifiers, the LNAs may take a variety of forms. In some examples LNAs 242 may include distributed LNAs, comprising transmission lines and semiconductor switching components. The LNAs may also be integrated onto an IC. LNAs may further be integrated into modules or packages, and connected to a plurality of channels 260 via a PCB, wires, transmission line, wave guide, twisted pair, or other signal distribution method. Due to the variability in manufacturing and placement, LNAs of the same design, may produce variable gain. LNA gain may not be easily adjusted. As such, in some examples, the LNA may also incorporate a variety of adjustable gain attenuators before connecting to the receiver post processor 240.

In some examples of the receiver post process 240, the post processor may include the use of analog-to-digital-converters (ADCs) in the receiver post processor. ADCs are configured to take as an input analog signal and convert the result to a digital representation of the signal by periodically sampling the voltage of the input signal. The periodic voltage samples are represented as a stream of digital data. An ADC may only sample an electrical input signal with a periodic frequency of less than one half of the sampling rate of the ADC. Additionally, the ADC may be limited by the voltage range it can measure on an electrical input signal. The ADC may also be limited with quantization error, error produced from representing an electrical measurement as a discrete value. Each receive channel 260 may have an independent ADC. Each ADC may produce a digital data stream that is further processed by the receiver post processor. The receiver post processor may account and compensate for a variety of the ADC errors before combining the digital data streams into a power measurement data stream 214 from vertical polarity of the receive beam 248 and a power measurement data stream 216 from horizontal polarity of the receive beam 248. A process performed by the mobile communication device may determine, using the vertical power measurement data stream 214 and the horizontal power measurement data stream 216, whether biological tissue is proximate to an antenna array.

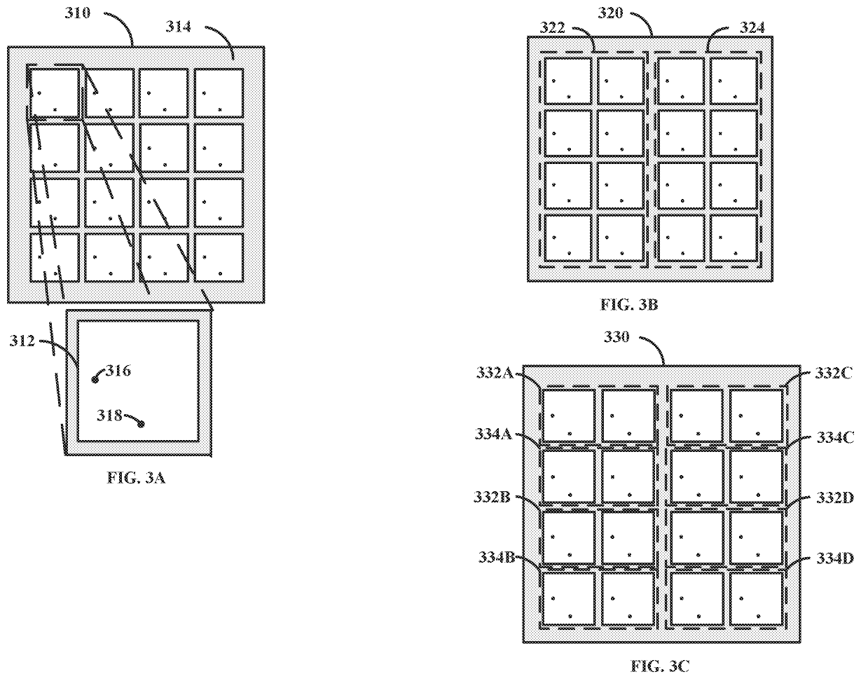

FIG. 3a through 3c are conceptual illustrations of examples of antenna arrays 310, 320, and 330, used in a mobile communication device, in accordance with one or more techniques of this disclosure. In some examples, the antenna arrays 310, 320, and 330 may be made of a plurality of antenna elements 312. The antenna elements 312 may be rectangular patch antennas, circular patch antennas, monopole antennas, dipole antennas, fractal antennas, planar inverted-F (PIFA) antennas, or other antenna topologies. The antenna elements may be constructed of conductive material such as copper, silver, gold, or other conductive metal. The conductive metal may be plated on a dielectric substrate 314 such as a PCB, silicone IC, or flexible polymer. Each element may be connected to a respective channel (e.g. receive channel or transmit channel) via an antenna feed. In some examples, an antenna feed may provide continuity via a contiguous conductive trace. Some examples of antenna feed mechanisms provide continuity between the circuitry and the antenna element. Some examples of feed mechanisms that provide continuity include a conductive via connection 316 and 318, a conductive trace, or wire bond connection. In some examples, the antenna feed may be a disjointed electromagnetic coupling mechanism. A disjointed electromagnetic coupling mechanism may include a slot, a capacitor, a wave guide, or other mechanism used to excite electromagnetic modes of an antenna. Different electromagnetic modes of an antenna element may be excited based on the orientation of the antenna feed, resulting in different antenna polarization characteristics.

In some examples of FIG. 3A an antenna element may be fed in different orientations to elicit different polarization characteristics. In some examples, a conductive via hole 316 may be oriented to excite electromagnetic modes in the antenna element that generate a horizontally polarized electromagnetic wave. In some examples, a conductive via hole 318 may be oriented to excite electromagnetic modes in the antenna element that generate a vertically polarized electromagnetic wave. In some examples, the antenna elements in the antenna array 310 may be configured as dual-polarized antenna elements. The plurality of transmit beams may be generated from a first antenna array using a plurality of dual-polarized antenna elements electromagnetically coupled to a plurality of channels. A mobile communication device may include a first antenna array and a second antenna array In some examples, the first antenna array comprises a plurality of transceivers electrically coupled to dual-polarized antenna elements. In some examples, the second antenna array may comprise a plurality of transceivers electrically coupled to dual-polarized antenna elements.

In some examples, a first antenna array and the second antenna array may be included in a single antenna array. A single antenna array may have multiple antenna elements. A plurality of the antenna elements may be configured as transmit elements and a separate plurality of elements may be configured as receive elements. In some examples a single antenna array can be configured to produce both a plurality of transmit beams and a plurality of receive beams simultaneously.

In the example of FIG. 3B some receive elements 322 may be collocated together on one part of the array and the plurality of the transmit elements 324 may be collocated together on another part of the array. Collocated may mean that all transmit elements are arranged in a particular contiguous grouping. In some examples, all of the transmit elements may be arranged in a particular contiguous grouping. In some examples, all the receive elements may be arranged in a particular contiguous grouping.

In the example of FIG. 3C some transmit elements 332A-D may be interspersed with some receive elements 334A-D in the array 330. Interspersing elements may decrease the amount of isolation between the transmit antenna elements and the receive antenna elements. Decreased isolation may lead to diminished detection capability. Isolation may be increased by using orthogonal polarity between adjacent elements. Isolation may also be increased with the use of metamaterials in between antenna elements.

In more examples of FIGS. 3A-3C, the antenna array 310, 320, or 330 may be reconfigurable as a transmit and receive array. In some examples of FIG. 3B, a reconfigurable transmit and receive array may comprise a plurality of elements, wherein each element may be configured as a receive element or a transmit element. In some examples, the elements configured as transmitting elements together form a transmit array and the elements configured as receiving elements together form a receive array. In some examples illustrated in FIG. 3a, the entire reconfigurable transmit receive array may be reconfigured as a transmit array or a receive array. Whereby a complete array of elements may be configured as transmit antenna elements, or receive antenna elements.

In some examples, antenna arrays 310, 320, or 330 may be configured to generate antenna beams, such as transmit beams 104 of FIG. 1 and receive beams 108 of FIG. 1. Beams may be similar in shape to the respective antenna array's gain pattern. The antenna array gain pattern, is a three dimensional pattern created by taking all the points for which an antenna array produces the same gain over a plurality of spatial locations. The antenna gain pattern is a conceptual idea illustrating where in space an antenna radiates the most power. In some examples, the transmit beam or receive beam generated by a large antenna array may have a very narrow beamwidth. A narrow beamwidth means that the antenna radiates a significant amount of its power over a narrow range of angles. Located outside that range of angels, a receiver would receive significantly less power than if it were in the narrow beamwidth of a main beam. Being outside the main beam, it is more difficult to receive energy from the transmit beam using a receiver with a receive beam.

In some examples, antenna arrays 310, 320 and, 330 may comprise many antenna elements. The design of the antenna array may be determined based on a number of considerations. Several considerations include physical antenna space, dielectric material of antenna substrate, frequency bandwidth of operation and center frequency of the antenna. The number of elements of the antenna array will be determined based on the dielectric content of the board substrate 314 and the dielectric and conductivity of the surrounding materials. The physical size of the antenna elements may be determined based on the center frequency of operation. All elements in an antenna array may be relatively isolated from each other electromagnetically. In some examples groups of antenna elements may be electromagnetically coupled together. These groups of antenna elements may comprise combinations up to and including all the elements of the array. These aspects of the array, along with many other aspects, factor into how the array will affect the gain of the plurality of transmit beams 104 and the plurality of receive beams 108.

In some examples, antenna gain impacts the amount of electromagnetic energy that may be reflected off of electromagnetic materials (e.g., biological tissue, and materials with similar electromagnetic properties to biological tissue) in close proximity to the antenna array. In some examples, antenna gain may also impact how a mobile communication device is able to transmit with the one or more transmission parameters. In some examples, a higher gain antenna may produce a narrow beamwidth transmit or receive beam. A narrow beamwidth beam may produce a stronger transmission link between transmitter and receiver. If the narrow beamwidth is steered away from adjacent tissue lower electromagnetic channel loss may be observed from an obstruction. Thereby better performance may be observed for a given transmit power level, when selecting a transmit beam that points in a direction away from the biological tissue.

In some examples of FIG. 3A-3C, antenna beams produced by antenna arrays 310, 320, and 330 may comprise a variety of characteristics. In some examples the antenna beams may be characterized by beamwidths. Beamwidth may be defined as a half power beamwidth (HPBW). The HPBW is an angle for which the gain pattern of an antenna beam transmits or receives, half the power (e.g., 3 decibels) sent to it or received by it. In some examples, the antenna beamwidth may be a pencil beam wherein the HPBW is only 1-3 degrees. In other examples, the antenna beamwidth may be 360 degrees, or omnidirectional. In some examples, the antenna beamwidth may have a HPBW between a pencil beam pattern and an omnidirectional beam pattern.

In some examples of FIG. 3A-3C, antenna beams may comprise the characteristic of polarization. Polarization is defined as the orientational relationship of the electric field vector in relation to the propagation vector in the far-field. A vertical polarization means the electric field oscillates up and down perpendicular to the surface of the earth, as the wave propagate tangentially to the surface of the earth. A horizontal polarization means the electric field oscillates left to right, tangentially to the surface of the earth as the wave propagates tangentially to the surface of the earth. A first antenna beam configured in one polarization may receive limited energy transmitted by a second antenna configured with an orthogonal polarization. One exception may occur if the transmit beam radiates energy that reflects off an object such as biological tissue. In some examples, a transmit beam configured to transmit in a first polarization may transmit energy that reflects off an object. The transmitted energy may change polarization upon reflection returning in a second polarization orthogonal to the first polarization. The second polarization may be measured with a receive beam configured to receive the second polarization.

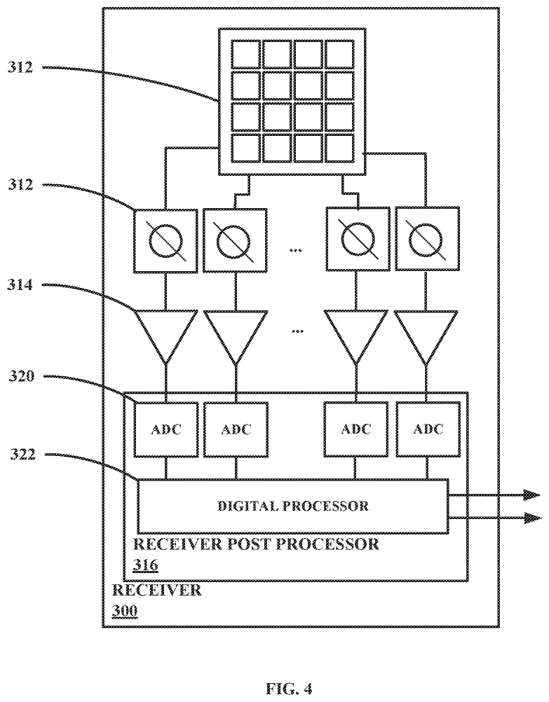

FIG. 4 is a conceptual block diagram illustrating an example of a dual polarized receiver used to process the signals received by a variety of receive beams, in accordance with one or more techniques of the disclosure. In some examples, antenna array 312, generates a variety of receive beams for which to receive electromagnetic signals. The receive beams may include all of the antenna gain properties of the transmit beams. One difference between the transmit beams and the receive beams is that the receive beams are received by antennas or antenna arrays operationally coupled to receivers. In comparison, transmit beams generated by antennas or antenna arrays are operationally coupled to transmitters.

One example of this disclosure includes a central processor that is configured to select a transmit beam from the plurality of transmit beams. The central processor may be an inherent part of the millimeter wave module 200. The transmit beam selected by the central processor may be realized by the transmitter 210. The central processor may also be configured to select a receive beam from a plurality of receive beams. The receive beam selected by the central processor may be realized by the receiver 212.

In one or more examples, the functions described by the central processor may be implemented in hardware, software, firmware, or any combination thereof. If implemented in software, the functions of the central processor may be stored on, or transmitted over, one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

In some examples, the central processor may be configured to instruct the transmitter processor 230 to transmit a plurality of signals down the plurality of channels 250. The central processor may also be configured to instruct the amplifiers 232 and phase shifters 234 to adjust phase delays to produce the selected transmit beam with the antenna array 236. The receiver 212 may be instructed to adjust the phase of a plurality of phase shifters 244 and a plurality of LNAs 242 to provide the appropriate signals received by the receive antenna array 246, to the receiver post processor 240.

In some examples the receiver post processor 240 may digitize the plurality of signals received on the plurality of channels 260. The receiver post processor 240 may further process the received signals into a first power measurement, received by the selected receive beam from the selected transmit beam. The first power measurement may include both a first orthogonal polarization and a second orthogonal polarization. Some orthogonal polarizations may include vertical and horizonal polarizations. Other orthogonal polarizations may include Left-Hand Circular Polarization (LHCP) and Right-Hand Circular Polarization (RHCP). In some examples, the power received in the vertical direction may be sent to the mobile device as a first orthogonal digital power signal 214. In some examples, the power received in the horizontal direction may be sent to the mobile device as a second orthogonal digital power signal 216.

A combination of the central processor in the mobile device, and the processor in the millimeter wave module 200, may change the transmit beam and the receive beam to a second transmit beam from a plurality of transmit beams and a second receive beam from a plurality of receive beams. The receiver post processor 240 may receive a second signal. The receiver post processor 240 may further process the second signal into a second power measurement, received by the selected receive beam and selected transmit beam. The second power measurement may include both a first orthogonal polarization and a second orthogonal polarization. The mobile device central processor in combination with the millimeter wave module processor may continue to select transmit beams and receive beams and measure vertical and horizonal power levels for each receiver transmit beam pair.

In some examples, a processor may form a matrix of the transmit to receiver beam combinations. Equation 1 represents the elements in a TRx Beam identification (ID), where the subscript “i” denotes the TRx beam ID number:

$$\begin{matrix}TRx Beam Identification for Each Transmit Receive Beam Pair & \\ TRx Beam ID : {TRx}_{i} = {( {Tx}_{j} , {Rx}_{k} )}_{i} & Equation l\end{matrix}$$

Equation 1 is a conceptual equation illustrating the configuration of various beams used to designate a value measured with the receive beam. In the example of Equation 1, the subscript “j” denotes the ID of the transmit beam used during the measurement and the subscript “k” denotes the ID of the receive beam used during the measurement. In the example of Equation 1, the power measurement taken with TRx Beam ID number “i” corresponds to a receive beam with an ID “k” configured to receive while a transmit beam with an ID “j” is configured to transmit. The measured power by the receive beam with may be designated as TRxᵢ. Taking a plurality of measurements with a plurality of receive beams and a plurality of transmit beams results in a plurality of TRxᵢ values. The plurality TRxᵢ values may be organized into a matrix illustrated in Equation 2:

$$\begin{matrix}TRx matrix of transmit receive beam pairs . & \\ TRx = [ \begin{matrix}{( {Tx}_{1} , {Rx}_{1} )}_{1} & {( {Tx}_{1} , {Rx}_{2} )}_{2} & … & {( {Tx}_{1} , {Rx}_{k} )}_{k} & … & {( {Tx}_{1} , {Rx}_{m} )}_{m} \\ {( {Tx}_{2} , {Rx}_{1} )}_{m + 1} & {( {Tx}_{2} , {Rx}_{2} )}_{m + 2} & … & {( {Tx}_{2} , {Rx}_{k} )}_{m + k} & … & {( {Tx}_{2} , {Rx}_{m} )}_{2 * m} \\ ⋮ & ⋮ & ⋱ & ⋮ & ⋮ & ⋮ \\ {( {Tx}_{j} , {Rx}_{1} )}_{( j - 1 ) * m + 1} & {( {Tx}_{j} , {Rx}_{2} )}_{( j - 1 ) * m + 2} & … & {( {Tx}_{j} , {Rx}_{k} )}_{( j - 1 ) * m + k} & … & {( {Tx}_{j} , {Rx}_{m} )}_{j * m} \\ ⋮ & ⋱ & … & ⋮ & ⋱ & ⋮ \\ {( {Tx}_{n} , {Rx}_{m} )}_{( n - 1 ) * m + 1} & {( {Tx}_{n} , {Rx}_{1} )}_{( n - 1 ) * m + 2} & … & {( {Tx}_{n} , {Rx}_{k} )}_{( n - 1 ) * m + k} & … & {( {Tx}_{n} , {Rx}_{m} )}_{n * m}\end{matrix} ] & Equation 2\end{matrix}$$

In the example of Equation 2, each element of the matrix may have a unique beam ID, corresponding to the subscript “i” of Equation 1. In the example of the first element in the matrix of Equation 2, (Tx₁, Rx₁)₁, indicates that the first transmit beam (Tx₁) was configured to transmit while a first receive beam (Rx₁) was configured to receive. A transmit receive beam pair corresponds to the transmit beam configured to transmit and the receive beam configure to receive. The transmit receive beam pair is designated as beam ID 1.

Another example is depicted by a second element in the second row and first column of the matrix of Equation 2, (Tx₂, Rx₁)ₘ₊₁. The second element shows that a second transmit beam (Tx₂) configured to transmit while a first receive beam (Rx₁) was configured to receive. The transmit receive beam pair is designated as beam ID m+1. A subscript “m” represents a number of unique receive beam configurations configurable by the hardware and software of the mobile communication device. The matrix of Equation 2 depicts some beam ID numbers with subscript variable “n”. “n” represents the number of unique transmit beam configurations configurable by the hardware and software of the mobile communication device.

In the example of Equation 2, each element of the matrix represents the power measured from a transmit receive beam pair. In some examples, the power measured is the power measured by the specified receive beam at the time the specified transmit beam was transmitting a signal. In some examples, the power measured may comprise two values when using a receive beam or transmit beam which is reconfigurable to receive or transmit with two different polarizations for each beam configuration. In the examples where the power measured is two values, the first value may be taken when both the transmit beam and the receive beam are configured with the same polarization. In the same example, the second value may be taken when the transmit beam is configured with an orthogonal polarization to the polarization of the receive beam. An example of a first value may be a power measured by a receive beam when a transmit beam is transmitting in the vertical polarization, and a receive beam is receiving in the vertical polarization. An example of a second value may be a power measured by a receive beam when a transmit beam is transmitting in the vertical polarization, and a receive beam is receiving in the horizontal polarization.

In some examples the transmit antenna array and the receive antenna array may be dual polarized. An antenna array that is dual polarized means that the antenna array may be reconfigurable to operate between different polarizations. In some examples, an antenna array configured to transmit may use both the horizonal polarization and vertical polarization while transmitting. In some examples, an antenna array configured to receive may use both the horizontal polarization and vertical polarization while receiving. In one example, a transmit antenna array may be a dual polarized antenna array, and therefore be able to switch between transmitting a transmit beam in a vertical polarization and transmitting a transmit beam in a horizontal polarization. In the same example, a receive antenna array may be a dual polarized antenna array and therefore able to switch between receiving a transmit beam in a vertical polarization and receiving a transmit beam in a horizontal polarization.

In some examples, four different values may be measured for a given transmit receive beam pair. In some examples, a first value may be a power measured by a receive beam when a transmit beam is transmitting in the vertical polarization, and a receive beam is receiving in the vertical polarization. In some examples, a second value may be a power measured by a receive beam when a transmit beam is transmitting in the vertical polarization, and a receive beam is receiving in the horizontal polarization. In some examples, a third value may be a power measured by a receive beam when a transmit beam is transmitting in the horizontal polarization, and a receive beam is receiving in the vertical polarization. In some examples, a fourth value may be a power measured by a receive beam when a transmit beam is transmitting in the horizontal polarization, and a receive beam is receiving in the horizontal polarization.

In some examples, the values taken by measuring different transmit receive beam polarizations may be consolidated into two matrices. In some examples, a first matrix may be used to represent the values measured using a vertically polarized receive beam over a plurality of transmit receive beam pairs (e.g., vertical TRx matrix). In some examples, a second matrix may be used to represent the values measured using a horizontally polarized receive beam over the plurality of transmit receive beam pairs (e.g., horizontal TRx matrix). The vertical TRx matrix and horizontal TRx matrix may be represented matrices of similar form and organization to the matrix of Equation 2.

In some examples, the transmit beams and receive beams are not generated with dual polarized antennas and do not have reconfigurable polarizations. In some examples, a difference power value may be calculated once two or more transmit receive beam pairs have been measured. In some examples, a difference power matrix may be created from a plurality of difference power values. The difference power matrix may be defined by Equation 3.

$$\begin{matrix}Difference ( Rx ) Power Matrix & \\ Δ Rx {=}^{def} = [ \begin{matrix}{Δ}_{1 , 1} & {Δ}_{1 , 2} & … & {Δ}_{1 , k} & … & {Δ}_{1 , m} \\ {Δ}_{2 , 1} & {Δ}_{2 , 2} & … & {Δ}_{2 , k} & … & {Δ}_{2 , m} \\ ⋮ & ⋮ & ⋱ & ⋮ & ⋮ & ⋮ \\ {Δ}_{j , 1} & {Δ}_{j , 2} & … & {Δ}_{j , k} & … & {Δ}_{j , m} \\ ⋮ & … & … & … & ⋱ & ⋮ \\ {Δ}_{n , 1} & {Δ}_{n , 2} & … & {Δ}_{n , k} & … & {Δ}_{n , m}\end{matrix} ] & Equation 3\end{matrix}$$

Each element (e.g., Δ_{j,k}) in matrix ΔRx may be a difference between two power values measured by two transmit receive beam pairs (e.g., represented by two elements in matrix TRx). In an example of an element of Equation 3, Δ_{1,1}, a power measurement taken with a transmit receive beam pair corresponding to TRx beam ID “1” is subtracted from a power measurement taken with a transmit receive beam pair corresponding to TRx beam ID “1.” In another example of an element of Equation 3, Δ_{2,1}, a power measurement taken with a transmit receive beam pair corresponding to TRx beam ID “2” is subtracted from a power measurement taken with a transmit receive beam pair corresponding to TRx beam ID “1.”

In some examples, the transmit beams and receive beams may be generated with dual polarized antennas configured to switch between different polarizations. In examples where transmit beams and receive beams are received with dual polarized antennas and reconfigurable polarizations, the difference power value may include two values. The two values may be represented via Δ_{x,y}, in Equation 4, described below:

$$\begin{matrix}Difference ( Rx ) Power Matrix with Orthogonal Polarizations & \\ {Δ}_{x , y} = ( {( {( {Tx}_{j} , {Rx}_{k} )}_{x} - {( {Tx}_{j} , {Rx}_{k} )}_{y} )}_{V} , {( {( {Tx}_{j} , {Rx}_{k} )}_{x} - {( {Tx}_{j} , {Rx}_{k} )}_{y} )}_{H} ) & Equation 4\end{matrix}$$

In the example of Equation 4, Δ_{x,y} represents two values, a different power value in the vertical orientation and the difference power value in the horizontal polarization. A first transmit receive beam pair with TRx beam ID “x” is separated into a vertical component (e.g., “V”) and a horizontal component (e.g., “H”). Similarly, a second transmit receive beam pair with TRx beam ID “y” is separated into a vertical component (e.g., “V”) and a horizontal component (e.g., “H”). Once the two pairs of measurement are separated into their respective polarizations, a difference may be calculated between their respective polarizations. A difference may be calculated by subtracting the vertical component of the TRx beam ID “y” from the vertical component of the TRx beam ID “x,” and subtracting the vertical horizontal component of the TRx beam ID “y” form the horizontal component of the TRx beam ID “x.” In some examples, further calculations may be performed to the difference pair. In one example, a simple sum of the vertical and horizontal polarizations may be performed to get a single value from the two polarization values representing the difference power value. In one example, an absolute value, or vector magnitude calculation may be performed to get a single value from the two polarization values representing the difference power value.

A conceptual graphical representation of the difference power matrix may be plotted against the TRx beam IDs. The difference power matrix may be determined in a variety of environments. The variety of environments may include placing a variety of objects near the mobile communication device and plotting the receive power across a variety of TRx beam IDs.

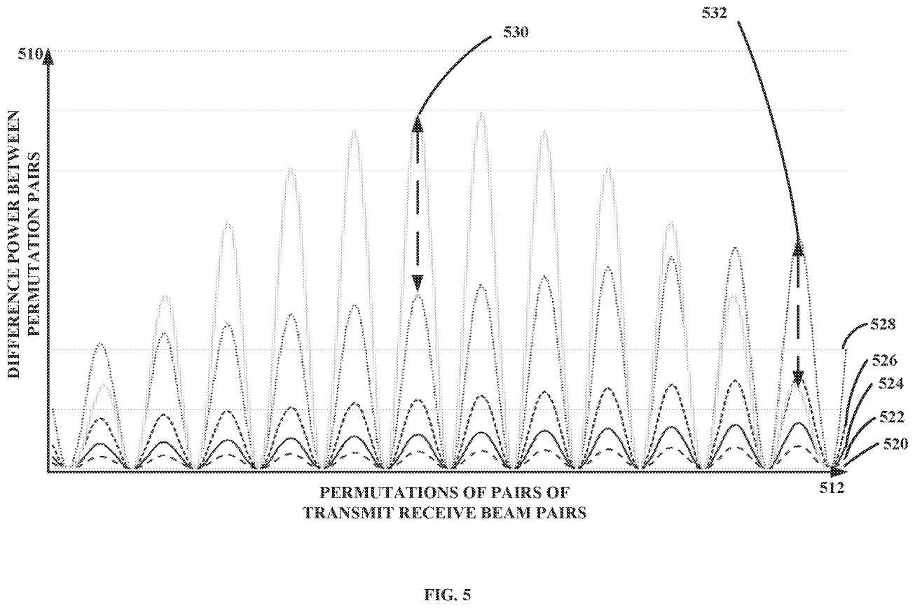

FIG. 5 is a conceptual graph illustrates an example of a difference power matrix plotted against a plurality of TRx beam IDs in a variety of environments, in accordance with one or more techniques of the disclosure. The plot of FIG. 5 is a line chart plotted on a graph having a single abscissa axis and a single ordinate axis. The abscissa axis represents permutations of pairs of transmit receive beam pairs. The permutations may be represented using the corresponding TRx beam ID. The ordinate axis represents difference power between permutation pairs. In some examples, difference power between permutation pairs represent the difference power values calculated in Equation 3. In some examples, difference power between permutation pairs represent the difference power values calculated in Equation 4. The graph of FIG. 5 represents plots of difference power values, calculated across a plurality of permutations, and calculated in a plurality of environments.

In the example of FIG. 5, a plurality of environments was calculated to show how the particular transmit receive beam pairs within the plurality of transmit receive beam pairs, may be used to indicate the presence of biological tissue. The plot corresponding to biological tissue 528, represent difference power measurement taken across a plurality of transmit receive beam pairs. A plot corresponding to a second environment 526, a plot corresponding to a third environment 524, a plot corresponding to a fourth environment 522, and a plot corresponding to a fifth environment 520 are illustrated in the graph of FIG. 5. In the example of FIG. 5, the fourth environment may be free space. Free space may designate an environment where the mobile communication device is position in a location where there are a limited number of materials that would generate reflections of energy from the transmit beam. One example of free space may be an anechoic chamber. The fifth environment 520 may be metal. Metal may have a high conductivity and cause significant reflections of electromagnetic energy. In some Examples of FIG. 5, metal may have higher values of difference power 530) then other environments at a first unique plurality of pairs of transmit receive beams. In some Examples, of FIG. 5, metal may have lower values of difference power than biological tissue. In some examples, biological tissue (e.g., human hand) may have higher values of difference power 532 than other environments, at a second unique plurality of pairs of transmit receive beams.

In the example of FIG. 5, a difference power between permutation pairs, plotted against permutations of pairs of transmit receive beams pairs, may indicate which pairs, of the transmit receive beam pairs, should be used to detect biological tissue. Processing difference power between beam pairs may be data intensive and time limiting for the central processor of the mobile communication device. In some examples, calculating the difference power between all permutation pairs may be time limiting whereas calculating the difference between a limited number of pairs may not be time limiting. Determining which particular beam pairs in the limited number of beam pairs, should be used to compare beam pairs on the mobile communication device limits processing resources, while enhancing accuracy of detection.

In the example of FIG. 5, pairs of transmit receive beam pairs may be selected for use in comparing transmit beam pairs for determining whether biological tissue is proximate to an antenna array. Measuring, and plotting, the difference power with respect to a plurality of transmit receive beam pairs, across a variety of materials, provides an indication of which transmit receive beam pairs should be used in the comparison of transmit receive beam pairs in accordance with the techniques of the disclosure. In some examples, metal may have higher values of difference power 530 than other environments for a first unique plurality of transmit receive beam pairs. The first unique plurality of transmit receive beam pairs may correspond to particular transmit receive beam pairs that may not be used for comparing beam pairs in accordance with techniques of the disclosure. In some examples, biological tissue (e.g., human hand) may have higher values of difference power 532, than other environments, at a second unique plurality of pairs of transmit receive beams. The second unique plurality of pairs may be used for comparing beam pairs in accordance with techniques of the disclosure.

In the example of FIG. 5, a comparison between transmit and receive beam pairs may be made using the plurality of transmit receive beam pairs that respond most significantly to the presence of biological tissue (e.g., human hand). These transmit receive beam pairs may be designated as comparison pairs. The difference power calculated at the comparison pairs may be further compared to a threshold value to determine whether biological tissue is present. The threshold value may be a value determined through measurement, testing, or calibration. The threshold value may correspond to a power level, when exceeded by the difference power values on the comparison pairs, gives an indication of high confidence that a human hand is in close proximity to the mobile device.

In some examples, the change in difference power values taken on comparison pairs in the presence of different object may correspond to the presence of biological tissue (e.g., human hand). In some examples, a change in difference power from a value when no objects are present to a value when biological tissue is proximate to the antenna, may be compared to a threshold value. In some examples, a change in power between a first difference power measurement at a first point in time and a second difference power measurement at a second point in time may be compared to the threshold value.

In some examples, if a difference power measurement is taken at a first point in time on the comparison pairs and a second difference power measurement is taken at a second point in time on the difference pairs, a change in power may be compared to the threshold value. If the change in power exceeds the threshold value, a central processor may determine an indication of significant confidence has been made, indicating that biological tissue is in close proximity to the mobile communication device.

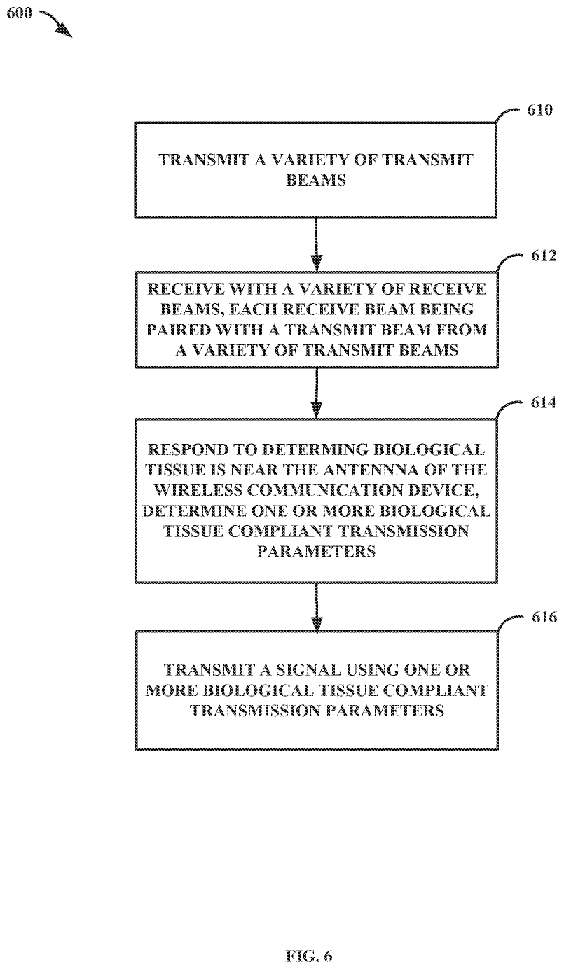

FIG. 6 is a conceptual flow chart illustrating an example of a method for detecting biological tissue proximate to an antenna array of a mobile communication device, in accordance with one or more techniques of the disclosure. In some examples of FIG. 6, a mobile communication device is configured to transmit a variety of transmit beams 610. Some examples of these beams are illustrated in FIG. 1 as transmit beams 104. In some examples the transmit beams may be generated by antenna arrays 310, 320 and 330, in FIGS. 3a, 3b, and 3c respectively. In some examples the transmit beams transmit electromagnetic energy that interact with surrounding materials before being reflected back toward the receive antenna array. In some examples, the transmit beams may have reconfigurable polarizations. Reconfigurable polarizations may include orthogonal polarizations some examples of orthogonal polarizations including vertical and horizontal as well as RHCP and LHCP.

In some examples, the mobile communication device may be configured to receive a variety of receive beams, each receive beam being paired with a transmit beam from a variety of transmit beams 612. In some examples, antenna array 106 may be configured as a receive array by electromagnetically coupling the antenna elements in antenna array 106 to one or more RF receivers. In some examples the receive beams may be generated by antenna arrays 310, 320 and 330, in FIGS. 3a, 3b, and 3c respectively. In some examples, the receive beams may be configured to receive electromagnetic energy on a given channel at the same time a transmit beam is transmitting. In some examples, the receive beams may have reconfigurable polarizations. Reconfigurable polarizations may include orthogonal polarizations some examples of orthogonal polarizations including vertical and horizontal as well as RHCP and LHCP.

In the example of FIG. 6, the mobile communication device may respond to determining biological tissue is near the antenna of the wireless communication device, determine one or more transmission parameters 614. In some examples, the mobile communication device may determine biological tissue is near the antenna of the wireless communication device by comparing a receive power measured by receive beam to a threshold value. In some examples, the receive power measured by a first receive beam may be compared to the receive power measured by a second receive beam and compared to a threshold value. In some examples, the receive power measured by a receive beam in the presence of a first transmitter may be compared to a receive power measured by a receive beam in the presence of a second transmitter. In some examples, any combination of receive beam measurement may be done with different orthogonal beam polarizations. In some examples, the power measured by the receive beam at a first moment in time may be compared to the power measured by the receive beam at a second moment in time and compared to a threshold value. Upon determining biological tissue is near the antenna of the wireless communication device, the wireless communication device may respond.

In the example of FIG. 6, the mobile communication device may respond to determining biological tissue is near the antenna of the wireless communication device, determine one or more transmission parameters 614. Some parameters may include the gain or power level of the power amplifiers 232 of FIG. 2, values of delay in phase shifters 234 of FIG. 2, or modulation techniques implemented by transmitter processor 230 of FIG. 2. In some examples, determining transmission parameters may include determine a communication message to send to a wireless communication system indicating an obstruction is present in the channel. The wireless communication system may include a base station and the mobile communication device may include a cell phone. In some examples, the transmission parameter may correspond to selecting a different communication module. In some examples, the transmission parameter may the ID of a different communication module to be selected for use on the next transmission. Selecting a different communication module may include switching RF radios to one that increases the amount of power received by the receiver while reducing the amount of electromagnetic energy lost to obstructing biological tissue. In some examples, the transmission parameter corresponds to an angular position of the main lobe and sidelobes of the transmit beams 104. In some examples, the angular position may include phase delays values implemented by phase shifters 234 of FIG. 2. Steering the main lobes or sidelobes of the transmit beams 104 may be performed by modifying the phase and amplitude of replicated signals among the electromagnetically coupled groups of antenna elements. For example, by changing the phase between horizontally adjacent elements, the main beam may be steered horizontally along the azimuth direction. Similarly, by changing the phase between vertically adjacent elements, the main beam may be steered vertically along the altitude direction. In some embodiments the phase shifts and gain modifications may be done by the transceivers.

In the example of FIG. 6, the mobile communication device may transmit a signal using one or more transmission parameters 616. In some examples, the signal transmitted by the mobile communication device may be transmitted wirelessly using transmit antenna array 102 forming transmit beam 104 to send signal 116 of FIG. 1. In some examples, the mobile communication device may be a cell telephone communicating with a base station, with a signal indicating to that an object or material obstruction is present in the communication channel. In some examples, the object or material obstruction may by biological tissue or material with the electromagnetic properties of biological tissue. In some cases, the signal may be a response to a wireless communication system, such as a base station, that the mobile communication device is switching to a different communication module. In some examples, the signal may be an indication of the receive power the mobile communication device is measuring from the wireless communication system. In some examples, the signal may by an indication of which comparison pairs the mobile communication device is using to compare difference power received by the plurality of transmit receive beam pairs.

In some examples, mobile communication devices are outputting high enough levels so as to impact the length of operating time of a battery from a given charge. When a mobile communication device is in close proximity to the user the body of the user will absorb electromagnetic energy from the transmit beam, degrading the signal received by the receiver. In response to the degraded signal, an increase in the power level of the transmitter will hasten that rate at which the operational time of the battery diminishes. In some examples, the close proximity of the human tissue to an antenna, or antenna array, may cause significant loss to the wireless communication channel. In some examples, significant losses in the wireless communication channel may cause the mobile communication device to compensate by increasing the amount of transmitted power, thereby lowering the operational time of the battery before needing to be recharged.

It may be desirable for the mobile communication device to determine whether biological tissue is in close proximity to the mobile communication device. For instance, the absorptive and reflective nature of human tissue may diminish the communication channel quality between the mobile communication device and the base station. Additionally, various regulations set standards for Specific Absorption Rates (SAR) by biological tissue against a cellular communication device. Determining that biological tissue is juxtaposed with the communication device may facilitate some control of the antenna gain in the direction of the base station by factoring in the location of biological tissue. Lowering the power of the transmitter while maintaining channel quality will extend the operational time of the battery between charging.

In accordance with one or more techniques of the disclosure, a mobile communications device may use an RF transmitter, electromagnetically coupled to a transmit antenna system, and an RF receiver, electromagnetically coupled to a receive antenna system, to determine whether a human hand is present near the device. The mobile communication device may transmit with a plurality of transmit beams, using a transmit antenna system, and receive with a plurality of receive beams, using the receive antenna system. In some examples, each transmit beam, from the plurality of transmit beams, may be paired with a receive beam, from the plurality of receive beams. In some examples, the receive power received by a first plurality of transmit receive beams pairs may be compared to the receive power received by a second plurality of transmit receive beam pairs. The comparison may include a difference calculation, which may result in a plurality of difference power measurements across permutations of transmit receive beam pairs. In some examples, the difference values may be compared to one or more predetermined threshold values to determine whether biological tissue is proximate to an antenna array, of the mobile communication device. In some examples, upon determining biological tissue is proximate to the antenna array of the mobile communication device, the mobile communication device may determine a plurality of transmission parameters. In some examples, the transmission parameters may include other parameters related to improving the efficiency of transmitter while maintaining the quality of the received signal by the receiver. In some examples, the mobile communication device may transmit a signal, indicating the value of one or more of the transmission parameters.

The following numbered examples may illustrate one or more aspects of this disclosure:

Example 1. A method comprising: transmitting, via a first antenna array of a mobile communication device, a plurality of transmit beams: receiving, via a second antenna array of the mobile communication device, a plurality of receive beams, a plurality of beam pairs each including a respective transmit beam of the plurality of transmit beams and a respective receive beam of the plurality of receive beams; determining, based on a comparison between beam pairs of the plurality of beam pairs, whether a biological tissue is proximate to the mobile communication device: responsive to determining that the biological tissue is proximate to the mobile communication device, determining one or more transmission parameters; and transmitting, with the one or more transmission parameters, a signal.

Example 2. The method of example 1, wherein the plurality of transmit beams are generated from a plurality of transceivers electrically coupled to dual-polarized antenna elements in the first antenna array.

Example 3. The method of example 1, wherein the plurality of receive beams are received by a plurality of transceivers electrically coupled to dual-polarized antenna elements in the second antenna array.

Example 4. The method of example 1, wherein the first antenna array and the second antenna array are included in a single antenna array.

Example 5. The method of example 1, wherein determining whether the biological tissue is proximate to the mobile communication device comprises: determining, for each respective beam pair of the plurality of beam pairs, a respective power level of a plurality of power levels, the respective power level representing an amount of power of a receive beam of the respective beam pair while a transmit beam of the respective beam pair is transmitted; and determining, based on a difference between a first receive power level of the plurality of power levels and a second receive power level of the plurality of receive power levels, whether the biological tissue is proximate to the mobile communication device.

Example 6. The method of example 5, wherein determining, based on the difference between the first receive power level and the second receive power level, whether the biological tissue is proximate to the mobile communication device comprises: responsive to determining that the difference is greater than a threshold value, determining that the biological tissue is proximate to the mobile communication device.

Example 7. The method of example 1, wherein the plurality of transmit beams comprise a plurality of modified copies of a same signal.

Example 8. The method of example 1, wherein the first antenna array is included in a current communication module of a plurality of communication modules of the mobile communication device, and wherein determining the one or more transmission parameters comprises one or more of: determining a transmit power; and selecting a different communication module of the plurality of communication modules.

Example 9. The method of example 1, further comprising: responsive to determining that the biological tissue is proximate to the mobile communication device, wirelessly communicating, to a base station, a message indicating that an obstruction exists.

Example 10. A mobile communication device comprising: a first antenna array configured to transmit a plurality of transmit beams: a second antenna array configured to receive a plurality of receive beams, a plurality of beam pairs each including a respective transmit beam of the plurality of transmit beams and a respective receive beam of the plurality of receive beams: one or more processors configured to determine whether an object is proximate to the mobile communication device based on a comparison between beam pairs of the plurality of beam pairs, whether an object is proximate to the mobile communication device; and a radio configured to determining one or more transmission parameters, and transmit a signal upon determining that an object is proximate to the mobile communication device, using the one or more transmission parameters.

Example 11. The mobile communication device of example 10, wherein the first antenna array comprises a plurality of transceivers electrically coupled to dual-polarized antenna elements.

Example 12. The mobile communication device of example 10, wherein the second antenna array comprises a plurality of transceivers electrically coupled to dual-polarized antenna elements.

Example 13. The mobile communication device of example 10, wherein the first antenna array and the second antenna array are included in a single antenna array.

Example 14. The mobile communication device of example 10, wherein, to determine whether the biological tissue is proximate to the mobile communication device, the one or more processors are configured to: determine, for each respective beam pair of the plurality of beam pairs, a respective power level of a plurality of power levels, the respective power level representing an amount of power of a receive beam of the respective beam pair while a transmit beam of the respective beam pair is transmitted; and determine, based on a difference between a first receive power level of the plurality of power levels and a second receive power level of the plurality of receive power levels, whether the biological tissue is proximate to the mobile communication device.

Example 15. The mobile communication device of example 14, wherein to determine, based on the difference between the first receive power level and the second receive power level, determine whether the biological tissue is proximate to the mobile communication device, the one or more processors are configured to: respond to determining that the difference is greater than a threshold value, and determine that the biological tissue is proximate to the mobile communication device.

Example 16. The mobile communication device of example 10, wherein the one or more processors are configured to modify copies of a same signal to generate a plurality of transmit beams.

Example 17. The mobile communication device of example 10, wherein the first antenna array is included in a current communication module of a plurality of communication modules of the mobile communication device, and wherein, to determine the one or more transmission parameters, the one or more processors are configured to, is configured to: determine a transmit power; and select a different communication module of the plurality of communication modules.

Example 18. The mobile communication device of example 10, wherein, to respond to determining that the biological tissue is proximate to the mobile communication device, one or more processors are configured to communicate to a base station, a message indicating that an obstruction exists.

Example 19. The mobile communication device of example 15, wherein, to calculate a change in power between a first receive power level at a first point in time and a second receive power level at a second point in time, the one or more processors are configured to compare the change in power to the threshold value.

Example 20. The mobile communication device of example 15, wherein, to measure a receive power level, the one or more processors are configured to measure vertical and horizonal power levels for each receiver transmit beam pair.

Various examples of the disclosure have been described. Any combination of the described systems, operations, or functions is contemplated. These and other examples are within the scope of the following claims.

1. A method comprising:
transmitting, via a first antenna array of a mobile communication device, a plurality of transmit beams;
receiving, via a second antenna array of the mobile communication device, a plurality of receive beams, a plurality of beam pairs each including a respective transmit beam of the plurality of transmit beams and a respective receive beam of the plurality of receive beams;
determining, based on a comparison between beam pairs of the plurality of beam pairs, whether a biological tissue is proximate to the mobile communication device;
responsive to determining that the biological tissue is proximate to the mobile communication device, determining one or more transmission parameters; and
transmitting, with the one or more transmission parameters, a signal.

2. The method of claim 1, wherein the plurality of transmit beams are generated from a plurality of transceivers electrically coupled to dual-polarized antenna elements in the first antenna array.

3. The method of claim 1, wherein the plurality of receive beams are received by a plurality of transceivers electrically coupled to dual-polarized antenna elements in the second antenna array.

4. The method of claim 1, wherein the first antenna array and the second antenna array are included in a single antenna array.

5. The method of claim 1, wherein determining whether the biological tissue is proximate to the mobile communication device comprises:
determining, for each respective beam pair of the plurality of beam pairs, a respective power level of a plurality of power levels, the respective power level representing an amount of power of a receive beam of the respective beam pair while a transmit beam of the respective beam pair is transmitted; and
determining, based on a difference between a first receive power level of the plurality of power levels and a second receive power level of the plurality of receive power levels, whether the biological tissue is proximate to the mobile communication device.

6. The method of claim 5, wherein determining, based on the difference between the first receive power level and the second receive power level, whether the biological tissue is proximate to the mobile communication device comprises:
responsive to determining that the difference is greater than a threshold value, determining that the biological tissue is proximate to the mobile communication device.

7. The method of claim 1, wherein the plurality of transmit beams comprise a plurality of modified copies of a same signal.

8. The method of claim 1, wherein the first antenna array is included in a current communication module of a plurality of communication modules of the mobile communication device, and wherein determining the one or more transmission parameters comprises one or more of:
determining a transmit power; and
selecting a different communication module of the plurality of communication modules.

9. The method of claim 1, further comprising:
responsive to determining that the biological tissue is proximate to the mobile communication device, wirelessly communicating, to a base station, a message indicating that an obstruction exists.

10. A mobile communication device comprising:
a first antenna array configured to transmit a plurality of transmit beams;
a second antenna array configured to receive a plurality of receive beams, a plurality of beam pairs each including a respective transmit beam of the plurality of transmit beams and a respective receive beam of the plurality of receive beams;
one or more processors configured to determine whether a biological tissue is proximate to the mobile communication device based on a comparison between beam pairs of the plurality of beam pairs; and
a radio configured to determining one or more transmission parameters, and transmit a signal upon determining that the biological tissue is proximate to the mobile communication device, using the one or more transmission parameters.

11. The mobile communication device of claim 10, wherein the first antenna array comprises a plurality of transceivers electrically coupled to dual-polarized antenna elements.

12. The mobile communication device of claim 10, wherein the second antenna array comprises a plurality of transceivers electrically coupled to dual-polarized antenna elements.

13. The mobile communication device of claim 10, wherein the first antenna array and the second antenna array are included in a single antenna array.

14. The mobile communication device of claim 10, wherein, to determine whether the biological tissue is proximate to the mobile communication device, the one or more processors are configured to:
determine, for each respective beam pair of the plurality of beam pairs, a respective power level of a plurality of power levels, the respective power level representing an amount of power of a receive beam of the respective beam pair while a transmit beam of the respective beam pair is transmitted; and
determine, based on a difference between a first receive power level of the plurality of power levels and a second receive power level of the plurality of receive power levels, whether the biological tissue is proximate to the mobile communication device.

15. The mobile communication device of claim 14, wherein to determine, based on the difference between the first receive power level and the second receive power level, determine whether the biological tissue is proximate to the mobile communication device, the one or more processors are configured to:
respond to determining that the difference is greater than a threshold value, and
determine that the biological tissue is proximate to the mobile communication device.

16. The mobile communication device of claim 10, wherein the one or more processors are configured to modify copies of a same signal to generate a plurality of transmit beams.

17. The mobile communication device of claim 10, wherein the first antenna array is included in a current communication module of a plurality of communication modules of the mobile communication device, and wherein, to determine the one or more transmission parameters, the one or more processors are configured to, is configured to:
determine a transmit power; and
select a different communication module of the plurality of communication modules.

18. The mobile communication device of claim 10, wherein, to respond to determining that the biological tissue is proximate to the mobile communication device, one or more processors are configured to communicate to a base station, a message indicating that an obstruction exists.

19. The mobile communication device of claim 15, wherein, to calculate a change in power between a first receive power level at a first point in time and a second receive power level at a second point in time, the one or more processors are configured to compare the change in power to the threshold value.

20. The mobile communication device of claim 15, wherein, to measure a receive power level, the one or more processors are configured to measure vertical and horizonal power levels for each receiver transmit beam pair.
